(19) United States
(12) Patent Application Publication
(10) Pub. No.: US 2025/0286787 A1
(43) Pub. Date: Sep. 11, 2025

(54) DIGITAL METHOD AND SYSTEM FOR CONSTRUCTING THREE-DIMENSIONAL COVERAGE DEMAND HEAT MAP

(71) Applicant: BEIJING INSTITUTE OF TECHNOLOGY, Beijing (CN)

(72) Inventors: Chen CHEN, Beijing (CN); Yuntian ZHANG, Beijing (CN); Linpeng JIA, Beijing (CN); Zonghong JIANG, Beijing (CN); Tongyu WU, Beijing (CN); Maobin LV, Beijing (CN); Fang DENG, Beijing (CN); Jie CHEN, Beijing (CN)

(73) Assignee: BEIJING INSTITUTE OF TECHNOLOGY, Beijing (CN)

(21) Appl. No.: 18/932,677

(22) Filed: Oct. 31, 2024

(30) Foreign Application Priority Data
Mar. 7, 2024 (CN) 202410262520.3

(51) Int. Cl. H04L 41/14; G06T 17/05; H04L 41/12; H04L 41/22

(52) U.S. Cl. CPC H04L 41/145; G06T 17/05; H04L 41/12; H04L 41/22

(57) ABSTRACT

A digital method and system for constructing a three-dimensional coverage demand heat map can generate a digital coverage demand heat map for a three-dimensional actual scenario. The method includes: firstly, performing layered discretization on a three-dimensional space; secondly, quantifying grid values of a heat map based on points of interest, detection directions, and weights of elevation layers; thirdly, proposing concepts of virtual points of interest and environmental regional division to achieve multiple coverage based on the points of interest and hierarchical coverage based on the detection directions; and finally, introducing pooling nodes and extracting a coverage demand heat map of a relatively low resolution, thereby achieving a trade-off between computational performance and computational cost. The method supports decision-makers in intuitively grasping the coverage demand situation and provides numerical input for downstream decision-making optimization tasks, which is beneficial for the deployment of sensor networks.

### CROSS REFERENCE TO THE RELATED APPLICATIONS

This application is based upon and claims priority to Chinese Patent Application No. 202410262520.3, filed on Mar. 7, 2024, the entire contents of which are incorporated herein by reference.

### TECHNICAL FIELD

The present disclosure relates to the technical field of situation assessment, and in particular to a digital method and system for constructing a three-dimensional coverage demand heat map, to support a decision-maker to intuitively grasp a coverage demand situation and provide a numerical input for a downstream decision-making optimization task.

### BACKGROUND

In practical applications such as target detection and environmental monitoring, it is crucial to deploy sensor networks to detect and cover the region of interest. However, in the era of informatization and intelligence, due to the complex actual environment and situation, a plurality of influencing factors, and large amount of information, it is hard to accurately measure and visually display the coverage demand. The coverage demand analysis based on situation assessment technology provides important upstream input for decision-making optimization of deployment and other tasks.

There have been some research and progress in the technical field of situation assessment, including analytic hierarchy process, principal component analysis, grey relational analysis, and Bayesian networks. These methods assign weights to different influencing factors based on their importance and perform linear or nonlinear weighted combinations of the weights to evaluate the situation value. However, these methods are unable to visually display the three-dimensional coverage demand situation and lack targeted modeling for key factors of the coverage demand analysis.

At present, there is no technical solution that can generate a digital coverage demand heat map for a three-dimensional actual scenario to support decision-makers in intuitively grasping the coverage demand situation.

### SUMMARY

In view of this, the present disclosure provides a digital method and system for constructing a three-dimensional coverage demand heat map. The present disclosure can generate a digital coverage demand heat map for a three-dimensional actual scenario, supporting decision-makers in intuitively grasping the coverage demand situation and providing numerical input for downstream decision-making optimization methods.

To achieve the above objective, a technical solution of the present disclosure includes the following steps:
step 1: dividing a three-dimensional environmental space into a plurality of layers in terms of elevation, and gridding each of the plurality of layers to achieve layered discretization of the three-dimensional environmental space;
step 2: quantifying grid values based on points of interest, detection directions, and weights of elevation layers;
step 3: generating a plurality of sets of virtual points of interest and performing environmental regional measurement to further simulate multiple coverage and hierarchical coverage;
step 4: introducing pooling nodes, and extracting a coverage demand heat map; and
step 5: displaying the three-dimensional coverage demand heat map based on a calculated value, and inputting the three-dimensional coverage demand heat map into a downstream decision-making optimization task.

Further, the step 1: dividing the three-dimensional environmental space into the plurality of layers in terms of the elevation, and gridding each of the plurality of layers to achieve the layered discretization of the three-dimensional environmental space specifically includes:
S101: dividing the three-dimensional environmental space into K layers in terms of the elevation, with an index being k=1, 2, . . . , where K is set to 3 as needed, corresponding to low, medium, and high elevations; and
S102: gridding each of the K layers into a total of I×J grids, with indexes being i=1, 2, . . . , I; j=1, 2, . . . , J; and constructing a heat map matrix F=(fᵢⱼₖ)_{I×J×K}, where a total number of elements in the heat map matrix is equal to a total number of all grids; and fᵢⱼₖ denotes a coverage demand value of each of the elements in the heat map matrix, initialized to 0.

Further, the step 2: quantifying the grid values based on the points of interest, the detection directions, and the weights of the elevation layers specifically includes:

S201: designing, based on a coverage demand of the points of interest, a Gaussian-like distribution to characterize the coverage demand value, where the Gaussian-like distribution is expressed as follows:

$$d = {‖ \vec{{x}_{trans}} ‖}_{2}$$

$${f}_{i j k} = \frac{1}{\sqrt{2 π}} \times {e}^{- \frac{{d}^{2}}{2 {σ}^{2}}}$$

where, d denotes a distance calculated based on a 2-norm; [symbol] trans denotes a two-dimensional coordinate of a grid point, specifically a coordinate of each grid point when a center of a grid point where one of the points of interest is located is taken as an origin of the coordinate; and σ denotes a settable parameter for regulating a shape of the Gaussian-like distribution;
S202: traversing each layer k and traversing a set M of the points of interest, with an index being m=1, 2, . . . M; and constructing a matrix Fᵣₑₐₗ^{(m)} with a same size as a heat map matrix F, where all elements in Fᵣₑₐₗ^{(m)} are initialized to 0; and in each traversal, an origin of coordinates of Fᵣₑₐₗ^{(m)} real is formed by a grid where a center of a point of interest m is located, and other grids undergo a translation operation compared to grids in F; and
calculating values of the elements in Fᵣₑₐₗ^{(m)} according to the expression of the Gaussian-like distribution, and adding calculated values of matrixes Fᵣₑₐₗ⁽¹⁾-Fᵣₑₐₗ^{(M)} to the heat map matrix F;
S203: defining D detection directions, with an index being d=1, 2, . . . , D where each of the D detection directions falls within an angle range of

$$\frac{360 °}{D}$$

and assigning, during a detection direction-based coverage demand analysis, element values in a boundary column of the heat map matrix F corresponding to the detection directions as an average value of all element values in the heat map matrix F; and
S204: setting different weights for different elevation layers.

Further, the translation operation in the S202 specifically includes horizontal and vertical translations required to move an element at (0,0) in an upper left corner of the matrix to the grid where the center of the point of interest m is located at each of the layers.

Further, the step 3: generating the plurality of sets of virtual points of interest and performing the environmental regional measurement to further simulate the multiple coverage and the hierarchical coverage specifically includes:
S301: generating the plurality of sets of virtual points of interest based on different detection directions, moving an actual point of interest towards the detection directions, calculating a coverage demand value in a neighborhood of the virtual points of interest based on a Gaussian-like distribution in the step 2, and adding the coverage demand value together with a coverage demand value generated by the actual point of interest to achieve the multiple coverage based on the points of interest and the hierarchical coverage based on the detection directions;
where, based on the above calculation, an actual coverage demand value generated by an m^{th} point of interest is:

$${F}^{( m )} = \frac{1}{n + 1} ( {F}_{r e a l}^{( m )} + {\sum }_{i = 1}^{n} {F}_{virtual}^{( m )} )$$

where, F^{(m)} denotes a total coverage demand value of the m^{th} point of interest; Fᵣₑₐₗ^{(m)} denotes the coverage demand value generated by the actual point of interest; Fᵥᵢᵣₜᵤₐₗ^{(m)} denotes a coverage demand value generated by an i^{th} virtual point of interest; and n denotes a number of the detection directions; and
S302: performing the environmental regional measurement: dividing, in consideration of coverage demands of the detection directions and the points of interest, an environmental area into U regions according to each of the detection directions, where a u^{th} region from far to near has a regional weight of

$$\frac{{α}_{max} - {α}_{min}}{U - 1} \times ( n - 1 ) + {α}_{min}$$

and αₘₐₓ and αₘᵢₙ are symmetrically selected around 1, with a difference not exceeding a set value; and
multiplying the regional weight by each element value in a heat map matrix, and acquiring final element values of the heat map matrix through a combined effect of a plurality of directions, where if a grid in the heat map matrix is located in a plurality of the regions simultaneously, the regional weight of the grid takes a maximum value among the plurality of the regions.

Further, in the step 4: introducing the pooling nodes, and extracting the coverage demand heat map to achieve a trade-off between computational performance and computational cost specifically includes:
selecting, based on a heat map matrix F calculated in the above step, a series of discrete points at equal intervals as the pooling nodes; and downsampling the pooling nodes, and aggregating element values of all grids within a predetermined range of grids where the pooling nodes are located, thereby extracting the coverage demand heat map.

The present disclosure further provides a digital system for constructing a three-dimensional coverage demand heat map, including a layered discretization module, a grid value quantification module, a multiple coverage and hierarchical coverage simulation module, a heat map extraction module, and a heat map display module, where
the layered discretization module is configured to divide a three-dimensional environmental space into a plurality of layers in terms of elevation, and grid each of the plurality of layers to achieve layered discretization of the three-dimensional environmental space;
the grid value quantification module is configured to quantify grid values based on points of interest, detection directions, and weights of elevation layers;
the multiple coverage and hierarchical coverage simulation module is configured to generate a plurality of sets of virtual points of interest and perform environmental regional measurement to further simulate multiple coverage and hierarchical coverage;
the heat map extraction module is configured to introduce pooling nodes, and extract a coverage demand heat map; and
the heat map display module is configured to display the three-dimensional coverage demand heat map based on a calculated value, and input the three-dimensional coverage demand heat map into a downstream decision-making optimization task.

Further, the layered discretization module is specifically configured to perform processes of:
dividing the three-dimensional environmental space into K layers in terms of the elevation, with an index being k=1, 2, . . . , K, where K is set to 3 as needed, corresponding to low, medium, and high elevations; and
gridding each of the K layers into a total of I×J grids, with indexes being i=1, 2, . . . , I; j=1, 2, . . . , J; and constructing a heat map matrix F=(fᵢⱼₖ)_{I×J×K}, where a total number of elements in the heat map matrix is equal to a total number of all grids; and fᵢⱼₖ denotes a coverage demand value of each of the elements in the heat map matrix, initialized to 0.

Further, the grid value quantification module is specifically configured to perform processes of:
S201: designing, based on a coverage demand of the points of interest, a Gaussian-like distribution to characterize the coverage demand value, where the Gaussian-like distribution is expressed as follows:

$$d = {‖ \vec{{x}_{trans}} ‖}_{2}$$

$${f}_{i j k} = \frac{1}{\sqrt{2 π}} \times {e}^{- \frac{{d}^{2}}{2 {σ}^{2}}}$$

where, d denotes a distance calculated based on a 2-norm; [symbol] trans denotes a two-dimensional coordinate of a grid point, specifically a coordinate of each grid point when a center of a grid point where one of the points of interest is located is taken as an origin of the coordinate; and σ denotes a settable parameter for regulating a shape of the Gaussian-like distribution;
S202: traversing each layer k and traversing a set M of the points of interest, with an index being m=1, 2, . . . M; and constructing a matrix Fᵣₑₐₗ^{(m)} with a same size as a heat map matrix F, where all elements in real are initialized to 0; in each traversal, an origin of coordinates of Fᵣₑₐₗ^{(m)} is formed by a grid where a center of a point of interest m is located, and other grids undergo a translation operation compared to grids in F; and the translation operation specifically includes horizontal and vertical translations required to move an element at (0,0) in an upper left corner of the matrix to the grid where the center of the point of interest m is located at each of the layers; and
calculating values of the elements in Fᵣₑₐₗ^{(m)} real according to the expression of the Gaussian-like distribution, and adding calculated values of matrixes Fᵣₑₐₗ⁽¹⁾-Fᵣₑₐₗ^{(M)} to the heat map matrix F;
S203: defining D detection directions, with an index being d=1, 2, . . . , D where each of the D detection directions falls within an angle range of

$$\frac{360 °}{D}$$

and assigning, during a detection direction-based coverage demand analysis, element values in a boundary column of the heat map matrix F corresponding to the detection direction as an average value of all element values in the heat map matrix F; and
S204: setting different weights for different elevation layers.

Further, the multiple coverage and hierarchical coverage simulation module is specifically configured to perform processes of:
S301: generating the plurality of sets of virtual points of interest based on different detection directions, moving an actual point of interest towards the detection directions, calculating a coverage demand value in a neighborhood of the virtual points of interest based on a Gaussian-like distribution in the step 2, and adding the coverage demand value together with a coverage demand value generated by the actual point of interest to achieve the multiple coverage based on the points of interest and the hierarchical coverage based on the detection directions;
where, based on the above calculation, an actual coverage demand value generated by an m^{th} point of interest is:

$${F}^{( m )} = \frac{1}{n + 1} ( {F}_{r e a l}^{( m )} + {\sum }_{i = 1}^{n} {F}_{virtual}^{( m )} )$$

where, F^{(m)} denotes a total coverage demand value of the m^{th} point of interest; Fᵣₑₐₗ^{(m)} denotes the coverage demand value generated by the actual point of interest; Fᵥᵢᵣₜᵤₐₗ^{(m)} denotes a coverage demand value generated by an i^{th} virtual point of interest; and n denotes a number of the detection directions; and
S302: performing the environmental regional measurement: dividing, in consideration of coverage demands of the detection directions and the points of interest, an environmental area into U regions according to each of the detection directions, where a u^{th} region from far to near has a regional weight of

$$\frac{{α}_{max} - {α}_{min}}{U - 1} \times ( n - 1 ) + {α}_{min}$$

and αₘₐₓ and αₘᵢₙ are symmetrically selected around 1, with a difference not exceeding a set value; and
multiplying the regional weight by each element value in a heat map matrix, and acquiring final element values of the heat map matrix through a combined effect of a plurality of directions, where if a grid in the heat map matrix is located in a plurality of the regions simultaneously, the regional weight of the grid takes a maximum value among the plurality of the regions; and
the heat map extraction module is specifically configured to select, based on the heat map matrix F, a series of discrete points at equal intervals as the pooling nodes; and downsample the pooling nodes, and aggregate element values of all grids within a predetermined range of grids where the pooling nodes are located, thereby extracting the coverage demand heat map.

### Advantages:

The present disclosure designs a digital method and system for constructing a three-dimensional coverage demand heat map, which can generate a digital coverage demand heat map for a three-dimensional actual scenario. The present method firstly performs layered discretization on a three-dimensional space. Secondly, the method quantifies grid values of a heat map based on points of interest, detection directions, and weights of elevation layers. Thirdly, the method proposes the concepts of virtual points of interest and environmental regional division to achieve multiple coverage based on the points of interest and hierarchical coverage based on the detection directions. Finally, the method introduces pooling nodes and extracts a coverage demand heat map of a relatively low resolution, thereby achieving a trade-off between computational performance and computational cost. The present method supports decision-makers in intuitively grasping the coverage demand situation, and provides numerical input for downstream decision-making optimization tasks, which is beneficial for many practical issues such as the deployment of sensor networks.

### BRIEF DESCRIPTION OF THE DRAWINGS

FIG. 1 is a flowchart of a digital method for constructing a three-dimensional coverage demand heat map according to the present disclosure;

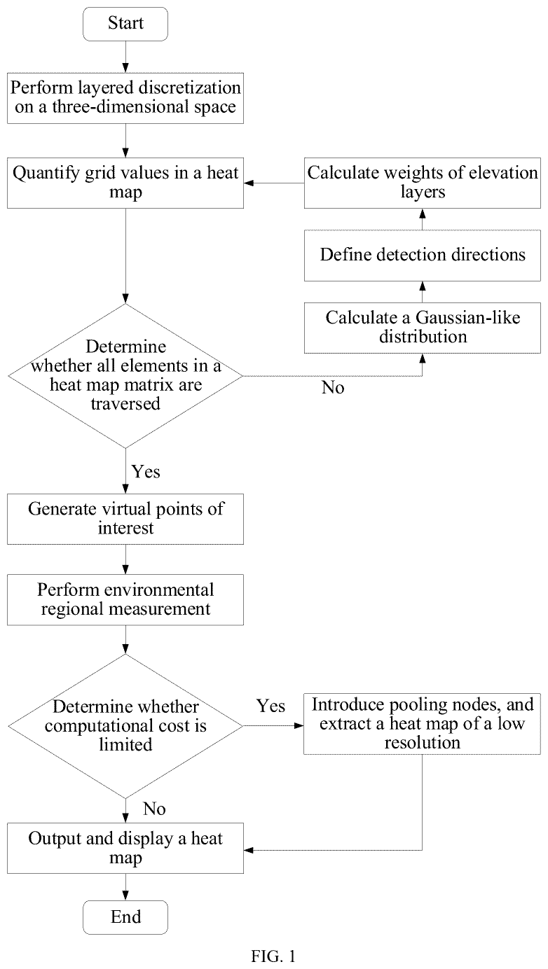

FIG. 2 is a schematic diagram of generating virtual points of interest according to the present disclosure; and

FIG. 3 is a schematic diagram of environmental regional measurement according to the present disclosure.

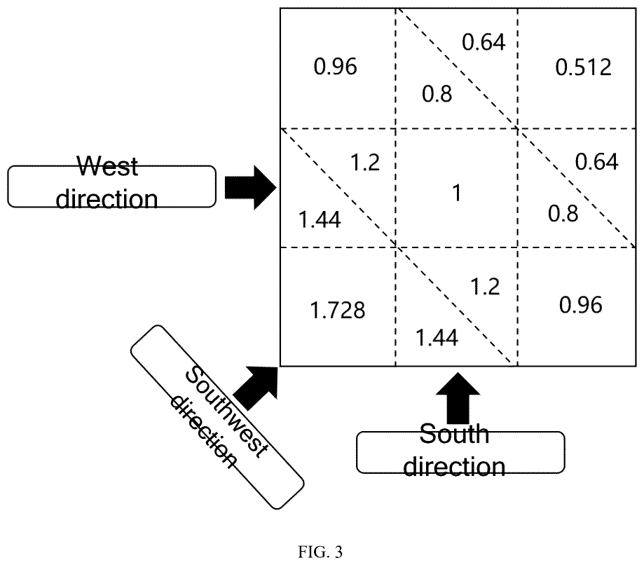

### DETAILED DESCRIPTION OF THE EMBODIMENTS

The present disclosure is described in detail below with reference to the drawings and embodiments.

### Embodiment 1

The present disclosure provides a digital method for constructing a three-dimensional coverage demand heat map. The method can generate a digital coverage demand heat map for a three-dimensional actual scenario, supporting decision-makers in intuitively grasping the coverage demand situation and providing numerical input for downstream decision-making optimization methods.

Step 1. Layered discretization is performed on a three-dimensional environmental space. The three-dimensional environmental space is divided into a plurality of layers in terms of elevation, and each layer is gridded.

1. The three-dimensional environmental space is divided into K layers in terms of elevation, with an index being k=1, 2, . . . , K where K is set to 3 as needed, corresponding to low, medium, and high elevations.

2. Each layer is gridded, where grids at each layer have a size of I×J, with indexes being i=1, 2, . . . , I; j=1, 2, . . . , J. A heat map matrix F=(fᵢⱼₖ)_{I×J×K} with a same grid size is constructed, where fᵢⱼₖ denotes a coverage demand value of each element in the heat map matrix, initialized to 0.

Step 2. Grid values are quantified based on points of interest, detection directions, and weights of the elevation layers.

1. Based on a coverage demand of the point of interest, considering that the coverage demand value decreases as the distance to the center of the point of interest increases, a Gaussian-like distribution is designed to characterize the coverage demand value, where the Gaussian-like distribution is expressed as follows:

$$d = {‖ \vec{{x}_{trans}} ‖}_{2} \\ {f}_{ijk} = \frac{1}{\sqrt{2 π}} \times {e}^{- \frac{{d}^{2}}{2 {σ}^{2}}}$$

where, d denotes a distance calculated based on a 2-norm; [symbol] denotes a two-dimensional coordinate of a grid point, specifically a coordinate of each grid point when a center of a grid point where one of the points of interest is located is taken as an origin of the coordinate; and σ denotes a settable parameter for regulating a shape of the Gaussian-like distribution. The three points of interest are corresponding to a of 3, 5, and 8, respectively.

2. Each layer k is traversed, and a set M of the points of interest are traversed, with an index being m=1, 2, . . . M. A matrix Fᵣₑₐₗ^{(m)} with a same size as a heat map matrix F is constructed, where all elements in Fᵣₑₐₗ^{(m)} are initialized to 0. In each traversal, an origin of coordinates of F′ is formed by a grid where a center of a point of interest m is located, and other grids undergo a translation operation compared to grids in F. The translation operation is specifically defined as horizontal and vertical translations required to move an element at (0,0) in an upper left corner of the matrix to the grid where the center of the point of interest m is located at each of the layers. Values of each element in Fᵣₑₐₗ^{(m)} are calculated according to the expression of the Gaussian-like distribution, and calculated values of matrixes Fᵣₑₐₗ⁽¹⁾-Fᵣₑₐₗ^{(M)} are added to the heat map matrix F.

3. In terms of the detection directions, there are eight main directions divided, D being 8, with each direction in an angle range of 45°. The specific directions are “west”, “southwest”, and “south”. In the detection direction-based coverage demand analysis, element values in a boundary column of the heat map matrix F are assigned larger values, which can specifically be an average value of all element values in the heat map matrix F. This processing method helps to more accurately depict the detection directions that decision-makers are concerned about in the environment, thereby strengthening monitoring and mastery of the edge regions in the environment.

4. According to different elevation layers, different weights are set, with a weight range of 0-1, reflecting the decision maker's emphasis on different elevations. For example, in order to better detect and cover a high-elevation target, the weight corresponding to the high-elevation layer can usually be set larger. The weight values for low, medium, and high-elevations are set to 0.3, 0.3, and 0.5, respectively.

Step 3. A plurality of sets of virtual points of interest are generated, and environmental regional measurement is performed to further simulate multiple coverage and hierarchical coverage.

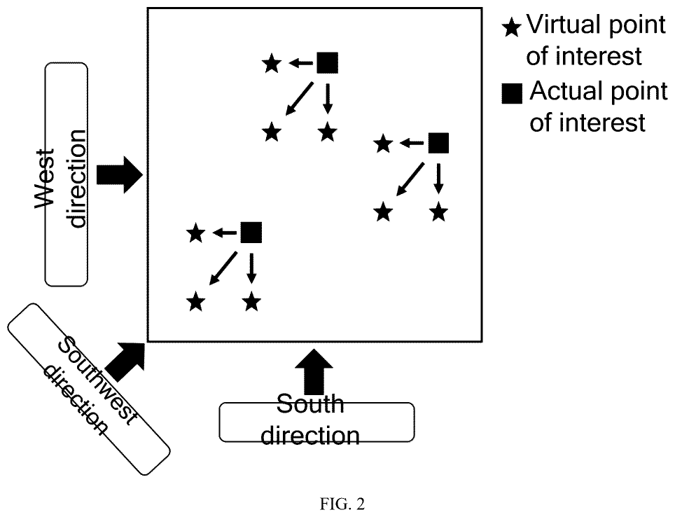

1. A plurality of sets of virtual points of interest are generated based on the different detection directions, and the actual point of interest is moved towards the detection directions, as shown in FIG. 2. In FIG. 2, within the environmental range, the square denotes the actual point of interest. Corresponding to the three detection directions of “west”, “southwest”, and “south”, three pentagram-shaped virtual points of interest are generated by moving the actual point of interest towards the detection directions. The coverage demand value in the neighborhood of the virtual point of interest is calculated based on a Gaussian-like distribution in the step 2, and is added together with a coverage demand value generated by the actual point of interest, thereby achieving multiple coverage based on the points of interest and hierarchical coverage based on the detection directions. Based on the above calculation, an actual coverage demand value generated by an m^{th} point of interest is:

$${F}^{( m )} = \frac{1}{n + 1} ( {F}_{r e a l}^{( m )} + {\sum }_{i = 1}^{n} {F}_{v i r t u a l}^{( m )} )$$

where, F^{(m)} denotes a total coverage demand value of the m^{th} point of interest; Fᵣₑₐₗ^{(m)} denotes the coverage demand value generated by the actual point of interest; virtual denotes a coverage demand value generated by an i^{th} virtual point of interest; and n denotes a number of the detection directions.

2. The environmental regional measurement is performed. In consideration of coverage demands of the detection directions and each point of interest, an environmental area is divided into U regions according to each direction, where a u^{th} region from far to near has a regional weight of

$$\frac{{α}_{max} - {α}_{min}}{U - 1} \times ( n - 1 ) + {α}_{min}$$

and αₘₐₓ and αₘᵢₙ are symmetrically selected around 1, with a difference not excessively large. Here, U is 3. αₘₐₓ and αₘᵢₙ are 1.2 and 0.8, respectively. A regional weight is multiplied by each element value in the heat map matrix, and final element values of the heat map matrix are acquired through a combined effect of a plurality of directions. If a grid in the heat map matrix is located in a plurality of the regions simultaneously, the regional weight of the grid takes a maximum value among the plurality of the regions.

Step 4. If computational cost is limited, pooling nodes are introduced, and a coverage demand heat map of a relatively low resolution is extracted, thereby achieving a trade-off between computational performance and computational cost. If the computational cost is sufficient, the pooling nodes may not be introduced. If it is limited, based on a heat map matrix F calculated in the above step, a series of discrete points at equal intervals are selected as the pooling nodes. The pooling nodes are downsampled, and the element values of all grids within a predetermined range of grids where the pooling nodes are located are aggregated, thereby extracting the coverage demand heat map of a relatively low resolution.

Step 5. The three-dimensional coverage demand heat map is displayed based on a calculated value, and is input into a downstream decision-making optimization task.

A three-dimensional coverage demand heat map is drawn based on the heat map matrix F=(fᵢⱼₖ)_{I×J×K} at a current moment. The colors of the heat map mainly include red and blue, and there is a gentle gradient between the two colors to show the changes in the element values of the heat map matrix. A region with high element values in the heat map matrix is represented in red, while a region with low element values is represented in blue.

### Embodiment 2

Another embodiment of the present disclosure further provides a digital system for constructing a three-dimensional coverage demand heat map, including a layered discretization module, a grid value quantification module, a multiple coverage and hierarchical coverage simulation module, a heat map extraction module, and a heat map display module.

The layered discretization module is configured to divide a three-dimensional environmental space into a plurality of layers in terms of elevation, and grid each layer to achieve layered discretization of the three-dimensional environmental space.

The grid value quantification module is configured to quantify grid values based on points of interest, detection directions, and weights of the elevation layers.

The multiple coverage and hierarchical coverage simulation module is configured to generate a plurality of sets of virtual points of interest and perform environmental regional measurement to further simulate multiple coverage and hierarchical coverage.

The heat map extraction module is configured to introduce pooling nodes, and extract a coverage demand heat map.

The heat map display module is configured to display the three-dimensional coverage demand heat map based on a calculated value, and input the three-dimensional coverage demand heat map into a downstream decision-making optimization task.

The layered discretization module is specifically configured to perform the following processes.

The three-dimensional environmental space is divided into K layers in terms of elevation, with an index being k=1, 2, . . . , K, where K is set to 3 as needed, corresponding to low, medium, and high elevations.

Each layer is gridded to generate a total of I×J grids at each layer, with indexes being i=1, 2, . . . , I; j=1, 2, . . . , J. A heat map matrix F=(fᵢⱼₖ)_{I×J×K} is constructed, where a total number of elements in the heat map matrix is equal to a total number of all grids; and fᵢⱼₖ denotes a coverage demand value of each element in the heat map matrix, initialized to 0.

The grid value quantification module is specifically configured to perform the following process.

S201. Based on a coverage demand of the point of interest, a Gaussian-like distribution is designed to characterize the coverage demand value, where the Gaussian-like distribution is expressed as follows:

$$d = {‖ \vec{{x}_{trans}} ‖}_{2} \\ {f}_{ijk} = \frac{1}{\sqrt{2 π}} \times {e}^{- \frac{{d}^{2}}{2 {σ}^{2}}}$$

where, d denotes a distance calculated based on a 2-norm; [symbol] denotes a two-dimensional coordinate of a grid point, specifically a coordinate of each grid point when a center of a grid point where one of the points of interest is located is taken as an origin of the coordinate; and σ denotes a settable parameter for regulating a shape of the Gaussian-like distribution.

S202. Each layer k is traversed, and a set M of the points of interest are traversed, with an index being m=1, 2, . . . M. A matrix Fᵣₑₐₗ^{(m)} with a same size as a heat map matrix F is constructed, where all elements in Fᵣₑₐₗ^{(m)} are initialized to 0. In each traversal, an origin of coordinates of Fᵣₑₐₗ^{(m)} real is formed by a grid where a center of a point of interest m is located, and other grids undergo a translation operation compared to grids in F. The translation operation specifically includes horizontal and vertical translations required to move an element at (0,0) in an upper left corner of the matrix to the grid where the center of the point of interest m is located at each of the layers.

Values of each element in Fᵣₑₐₗ^{(m)} are calculated according to the expression of the Gaussian-like distribution, and calculated values of matrixes Fᵣₑₐₗ⁽¹⁾-Fᵣₑₐₗ^{(M)} are added to the heat map matrix F.

S203. D detection directions are defined, with an index being d=1, 2, . . . , D where each of the D detection directions falls within an angle range of

$$\frac{360 °}{D}$$

During a detection direction-based coverage demand analysis, element values in a boundary column of the heat map matrix F corresponding to the detection direction are assigned as an average value of all element values in the heat map matrix F.

S204. Different weights are set based on different elevation layers.

The multiple coverage and hierarchical coverage simulation module is specifically configured to perform the following process.

S301. A plurality of sets of virtual points of interest are generated based on different detection directions, an actual point of interest is moved towards the detection directions, a coverage demand value in the neighborhood of the virtual point of interest is calculated based on a Gaussian-like distribution in the step 2, and the coverage demand value is added together with a coverage demand value generated by the actual point of interest to achieve the multiple coverage based on the points of interest and the hierarchical coverage based on the detection directions.

Based on the above calculation, an actual coverage demand value generated by an m^{th} point of interest is:

$${F}^{( m )} = \frac{1}{n + 1} ( {F}_{r e a l}^{( m )} + {\sum }_{i = 1}^{n} {F}_{v i r t u a l}^{( m )} )$$

where, F^{(m)} denotes a total coverage demand value of the m^{th} point of interest; Fᵣₑₐₗ^{(m)} denotes the coverage demand value generated by the actual point of interest; Fᵥᵢᵣₜᵤₐₗ^{(m)} denotes a coverage demand value generated by an i^{th} virtual point of interest; and n denotes a number of the detection directions.

S302. The environmental regional measurement is performed. In consideration of coverage demands of the detection directions and each point of interest, an environmental area is divided into U regions according to each direction, where a u^{th} region from far to near has a regional weight of

$$\frac{{α}_{max} - {α}_{min}}{U - 1} \times ( n - 1 ) + {α}_{min}$$

and αₘₐₓ and αₘᵢₙ are symmetrically selected around 1, with a difference not exceeding a set value.

The regional weight is multiplied by each element value in a heat map matrix, and final element values of the heat map matrix are acquired through a combined effect of a plurality of directions. If a grid in the heat map matrix is located in a plurality of the regions simultaneously, the regional weight of the grid takes a maximum value among the plurality of the regions.

The heat map extraction module is specifically configured to select, based on the heat map matrix F, a series of discrete points at equal intervals as the pooling nodes; and downsample the pooling nodes, and aggregate element values of all grids within a predetermined range of grids where the pooling nodes are located, thereby extracting the coverage demand heat map.

Overall, the above described are merely preferred embodiments of the present disclosure, and are not intended to limit the protection scope of the present disclosure. Any modification, equivalent substitution, improvement, etc. within the spirit and principles of the present disclosure shall fall within the scope of protection of the present disclosure.

1. A digital method for constructing a three-dimensional coverage demand heat map, comprising the following steps:
step 1: dividing a three-dimensional environmental space into a plurality of layers in terms of elevation, and gridding each of the plurality of layers to achieve layered discretization of the three-dimensional environmental space;
step 2: quantifying grid values based on points of interest, detection directions, and weights of elevation layers;
step 3: generating a plurality of sets of virtual points of interest and performing environmental regional measurement to further simulate multiple coverage and hierarchical coverage;
step 4: introducing pooling nodes, and extracting a coverage demand heat map; and
step 5: displaying the three-dimensional coverage demand heat map based on a calculated value and inputting the three-dimensional coverage demand heat map into a downstream decision-making optimization task.

2. The digital method for constructing the three-dimensional coverage demand heat map according to claim 1, wherein the step 1 comprises:
S101: dividing the three-dimensional environmental space into K layers in terms of the elevation, with an index being k=1, 2, . . . , K, wherein K is set to 3 as needed, corresponding to low, medium, and high elevations; and
S102: gridding each of the K layers into a total of I×J grids, with indexes being i=1, 2, . . . , I; j=1, 2, . . . , J; and constructing a heat map matrix F=(fᵢⱼₖ)_{I×J×K}, wherein a total number of elements in the heat map matrix F=(fᵢⱼₖ)_{I×J×K} is equal to a total number of all grids; and fᵢⱼₖ denotes a coverage demand value of each of the elements in the heat map matrix F=(fᵢⱼₖ)_{I×J×K}, initialized to 0.

3. The digital method for constructing the three-dimensional coverage demand heat map according to claim 1, wherein the step 2 comprises:
S201: designing, based on a coverage demand of the points of interest, a Gaussian-like distribution to characterize a coverage demand value, wherein the Gaussian-like distribution is expressed as follows:
$$d = {‖ \vec{{x}_{trans}} ‖}_{2} \\ {f}_{ijk} = \frac{1}{\sqrt{2 π}} \times {e}^{- \frac{{d}^{2}}{2 {σ}^{2}}}$$
wherein, d denotes a distance calculated based on a 2-norm; [symbol] denotes a two-dimensional coordinate of a grid point, wherein the two-dimensional coordinate of the grid point is a coordinate of each grid point when a center of a grid point where one of the points of interest is located is taken as an origin of the coordinate; and σ denotes a settable parameter for regulating a shape of the Gaussian-like distribution;
S202: traversing each layer k, and traversing a set M of the points of interest, with an index being m=1, 2, . . . M; and constructing a matrix Fᵣₑₐₗ^{(m)} with a same size as a heat map matrix F, wherein all elements in the matrix Fᵣₑₐₗ^{(m)} are initialized to 0; and wherein in each traversal, an origin of coordinates of the matrix Fᵣₑₐₗ^{(m)} is formed by a grid where a center of a point of interest m is located, and other grids undergo a translation operation compared to grids in the heat map matrix F; and
calculating values of the elements in the matrix Fᵣₑₐₗ^{(m)} according to an expression of the Gaussian-like distribution, and adding calculated values of matrixes Fᵣₑₐₗ⁽¹⁾-Fᵣₑₐₗ^{(M)} to the heat map matrix F;
S203: defining D detection directions, with an index being d=1, 2, . . . , D, wherein each of the D detection directions falls within an angle range of
$$\frac{360 °}{D}$$
and assigning, during a detection direction-based coverage demand analysis, element values in a boundary column of the heat map matrix F corresponding to the detection directions as an average value of all element values in the heat map matrix F; and
S204: setting different weights for different elevation layers.

4. The digital method for constructing the three-dimensional coverage demand heat map according to claim 3, wherein the translation operation in the S202 comprises horizontal and vertical translations required to move an element at (0,0) in an upper left corner of the matrix Fᵣₑₐₗ^{(m)} to the grid where the center of the point of interest m is located at each of the plurality of layers.

5. The digital method for constructing the three-dimensional coverage demand heat map according to claim 1, wherein the step 3 comprises:
S301: generating the plurality of sets of virtual points of interest based on different detection directions, moving an actual point of interest towards the detection directions, calculating a coverage demand value in a neighborhood of the plurality of sets of virtual points of interest based on a Gaussian-like distribution in the step 2, and adding the coverage demand value together with a coverage demand value generated by the actual point of interest to achieve the multiple coverage based on the points of interest and the hierarchical coverage based on the detection directions;
wherein, based on a calculation above, an actual coverage demand value generated by an m^{th} point of interest is:
$${F}^{( m )} = \frac{1}{n + 1} ( {F}_{r e a l}^{( m )} + {\sum }_{i = 1}^{n} {F}_{v i r t u a l}^{( m )} )$$
wherein, F^{(m)} denotes a total coverage demand value of the m^{th} point of interest; Fᵣₑₐₗ^{(m)} denotes the coverage demand value generated by the actual point of interest; Fᵥᵢᵣₜᵤₐₗ^{(m)} denotes a coverage demand value generated by an i^{th} virtual point of interest; and n denotes a number of the detection directions; and
S302: performing the environmental regional measurement, dividing, in consideration of coverage demands of the detection directions and the points of interest, an environmental area into U regions according to each of the detection directions, wherein a u^{th} region from far to near has a regional weight of
$$\frac{{α}_{max} - {α}_{min}}{U - 1} \times ( n - 1 ) + {α}_{min}$$
and αₘₐₓ and αₘᵢₙ are symmetrically selected around 1, with a difference not exceeding a set value; and
multiplying the regional weight by each element value in a heat map matrix, and acquiring final element values of the heat map matrix through a combined effect of a plurality of the detection directions, wherein if a grid in the heat map matrix is located in a plurality of the U regions simultaneously, a regional weight of the grid takes a maximum value among the plurality of the U regions.

6. The digital method for constructing the three-dimensional coverage demand heat map according to claim 1, wherein the step 4 comprises:
selecting, based on a heat map matrix F calculated in the steps 1, 2, and 3, a series of discrete points at equal intervals as the pooling nodes; and downsampling the pooling nodes, and aggregating element values of all grids within a predetermined range of grids where the pooling nodes are located, thereby extracting the coverage demand heat map.

7. A digital system for constructing a three-dimensional coverage demand heat map, comprising a layered discretization module, a grid value quantification module, a multiple coverage and hierarchical coverage simulation module, a heat map extraction module, and a heat map display module, wherein
the layered discretization module is configured to divide a three-dimensional environmental space into a plurality of layers in terms of elevation, and grid each of the plurality of layers to achieve layered discretization of the three-dimensional environmental space;
the grid value quantification module is configured to quantify grid values based on points of interest, detection directions, and weights of elevation layers;
the multiple coverage and hierarchical coverage simulation module is configured to generate a plurality of sets of virtual points of interest and perform environmental regional measurement to further simulate multiple coverage and hierarchical coverage;
the heat map extraction module is configured to introduce pooling nodes, and extract a coverage demand heat map; and
the heat map display module is configured to display the three-dimensional coverage demand heat map based on a calculated value and input the three-dimensional coverage demand heat map into a downstream decision-making optimization task.

8. The digital system for constructing the three-dimensional coverage demand heat map according to claim 7, wherein the layered discretization module is configured to perform processes of:
dividing the three-dimensional environmental space into K layers in terms of the elevation, with an index being k=1, 2, . . . , K, wherein K is set to 3 as needed, corresponding to low, medium, and high elevations; and
gridding each of the K layers into a total of I×J grids, with indexes being i=1, 2, . . . , I; j=1, 2, . . . , J; and constructing a heat map matrix F=(fᵢⱼₖ)_{I×J×K}, wherein a total number of elements in the heat map matrix F=(fᵢⱼₖ)_{I×J×K}, is equal to a total number of all grids; and fᵢⱼₖ denotes a coverage demand value of each of the elements in the heat map matrix F=(fᵢⱼₖ)_{I×J×K}, initialized to 0.

9. The digital system for constructing the three-dimensional coverage demand heat map according to claim 7, wherein the grid value quantification module is configured to perform processes of:
S201: designing, based on a coverage demand of the points of interest, a Gaussian-like distribution to characterize a coverage demand value, wherein the Gaussian-like distribution is expressed as follows:
$$d = {‖ \vec{{x}_{trans}} ‖}_{2} \\ {f}_{ijk} = \frac{1}{\sqrt{2 π}} \times {e}^{- \frac{{d}^{2}}{2 {σ}^{2}}}$$
wherein, d denotes a distance calculated based on a 2-norm; [symbol] denotes a two-dimensional coordinate of a grid point, wherein the two-dimensional coordinate of the grid point is a coordinate of each grid point when a center of a grid point where one of the points of interest is located is taken as an origin of the coordinate; and σ denotes a settable parameter for regulating a shape of the Gaussian-like distribution;
S202: traversing each layer k, and traversing a set M of the points of interest, with an index being m=1, 2, . . . M; and constructing a matrix Fᵣₑₐₗ^{(m)} with a same size as a heat map matrix F, wherein all elements in the matrix Fᵣₑₐₗ^{(m)} are initialized to 0; and wherein in each traversal, an origin of coordinates of the matrix Fᵣₑₐₗ^{(m)} is formed by a grid where a center of a point of interest m is located, and other grids undergo a translation operation compared to grids in the heat map matrix F; and the translation operation comprises horizontal and vertical translations required to move an element at (0,0) in an upper left corner of the matrix Fᵣₑₐₗ^{(m)} to the grid where the center of the point of interest m is located at each of the plurality of layers; and
calculating values of the elements in the matrix Fᵣₑₐₗ^{(m)} according to an expression of the Gaussian-like distribution, and adding calculated values of matrixes Fᵣₑₐₗ⁽¹⁾-Fᵣₑₐₗ^{(M)} to the heat map matrix F;
S203: defining D detection directions, with an index being d=1, 2, . . . , D, wherein each of the D detection directions falls within an angle range of
$$\frac{360 °}{D}$$
and assigning, during a detection direction-based coverage demand analysis, element values in a boundary column of the heat map matrix F corresponding to the detection directions as an average value of all element values in the heat map matrix F; and
S204: setting different weights for different elevation layers.

10. The digital system for constructing the three-dimensional coverage demand heat map according to claim 7, wherein the multiple coverage and hierarchical coverage simulation module is configured to perform processes of:
S301: generating the plurality of sets of virtual points of interest based on different detection directions, moving an actual point of interest towards the detection directions, calculating a coverage demand value in a neighborhood of the plurality of sets of virtual points of interest based on a Gaussian-like distribution in the step 2, and adding the coverage demand value together with a coverage demand value generated by the actual point of interest to achieve the multiple coverage based on the points of interest and the hierarchical coverage based on the detection directions;
wherein, based on a calculation above, an actual coverage demand value generated by an m^{t}h point of interest is:
$${F}^{( m )} = \frac{1}{n + 1} ( {F}_{r e a l}^{( m )} + {\sum }_{i = 1}^{n} {F}_{v i r t u a l}^{( m )} )$$
wherein, F^{(m)} denotes a total coverage demand value of the m^{th} point of interest; Fᵣₑₐₗ^{(m)} denotes the coverage demand value generated by the actual point of interest; Fᵥᵢᵣₜᵤₐₗ^{(m)} denotes a coverage demand value generated by an i^{th} virtual point of interest; and n denotes a number of the detection directions; and
S302: performing the environmental regional measurement, dividing, in consideration of coverage demands of the detection directions and the points of interest, an environmental area into U regions according to each of the detection directions, wherein a u^{th} region from far to near has a regional weight of
$$\frac{{α}_{max} - {α}_{min}}{U - 1} \times ( n - 1 ) + {α}_{min}$$
and αₘₐₓ and αₘᵢₙ are symmetrically selected around 1, with a difference not exceeding a set value; and
multiplying the regional weight by each element value in a heat map matrix F, and acquiring final element values of the heat map matrix F through a combined effect of a plurality of the detection directions, wherein if a grid in the heat map matrix F is located in a plurality of the U regions simultaneously, a regional weight of the grid takes a maximum value among the plurality of the U regions; and
the heat map extraction module is configured to select, based on the heat map matrix F, a series of discrete points at equal intervals as the pooling nodes; and downsample the pooling nodes, and aggregate element values of all grids within a predetermined range of grids where the pooling nodes are located, thereby extracting the coverage demand heat map.
